(19) United States
(12) Patent Application Publication
(10) Pub. No.: US 2025/0008540 A1
(43) Pub. Date: Jan. 2, 2025

(54) POWER CONSUMPTION MANAGEMENT OF RADIO ACCESS NETWORK (RAN) NODE

(71) Applicant: Telefonaktiebolaget LM Ericsson (publ), Stockholm (SE)

(72) Inventors: XiaoLin Pu, Beijing (CN); Qi Zhang, Beijing (CN); Hui Wu, Beijing (CN); Fan Zhang, Beijing (CN); Changqing Yuan, Beijing (CN)

(21) Appl. No.: 18/709,767

(22) PCT Filed: Nov. 12, 2021
(86) PCT No.: PCT/CN2021/130343

§ 371 Date: May 13, 2024

(51) Int. Cl. H04W 72/52; H04W 72/0453

(52) U.S. Cl. CPC H04W 72/52; H04W 72/0453

(57) ABSTRACT

The present disclosure is related to methods and RAN nodes for power consumption management. The method at a first RAN node for managing power consumption of a second RAN node comprises: determining whether one or more first conditions related to a traffic load of the second RAN node are fulfilled or not; and transmitting, to the second RAN node, a first message for requesting the second RAN node to operate in a first state with less frequency resource than that previously configured for the second RAN node in response to determining that the one or more first conditions are fulfilled.

### TECHNICAL FIELD

The present disclosure is related to the field of telecommunication, and in particular, to methods and RAN nodes for power consumption management.

### BACKGROUND

With the development of the electronic and telecommunications technologies, mobile devices, such as mobile phones, smart phones, laptops, tablets, vehicle mounted devices, become an important part of our daily lives. To support a numerous number of mobile devices, a Radio Access Network (RAN), such as a fourth generation (4G) Long Term Evolution (LTE) RAN or a fifth generation (5G) New Radio (NR) RAN, will be required.

Carriers have been looking at energy efficiency for a few years now, but 5G will bring this to top of mind because it is going to use more energy than 4G. Some carriers spend on average 5% to 6% of their operating expenses, excluding depreciation and amortization, on energy costs, and this is expected to rise with the shift from 4G to 5G.

A typical 5G base station consumes up to twice or more the power of a 4G base station, and energy costs can grow even more at higher frequencies, due to a need for more antennas and a denser layer of small cells. Edge computing facilities needed to support local processing and new internet of things (IoT) services will also add to overall network power usage.

Warnings of more power consumption are coming from some telecommunication carriers that are leading the world in 5G deployments. In November 2019, according to a Chinese telecommunication carrier, its electricity costs were rising fast with 5G. It has tried using lower cost deployments of MIMO antennas, specifically 32T32R and sometimes 8T8R rather than 64T64R. However, 5G base stations are carrying five times the traffic as when equipped with only 4G, pushing up power consumption.

According to data on Remote Radio Unit (RRU)/Baseband Unit (BBU) needs per site, a typical 5G site has power needs of over 11.5 kilowatts, up nearly 70% from a base station deploying a mix of 2G, 3G, and 4G radios. 5G macro base stations may require several new, power-hungry components, including microwave or millimeter wave transceivers, field-programmable gate arrays (FPGAs), faster data converters, high-power/low-noise amplifiers and integrated MIMO antennas.

The increased power demands of a 5G base station can create several problems:
Insufficient AC power supply;
Insufficient battery capacity: more backup battery capacity is needed, yet traditional lead-acid batteries have low energy density and their capacities are difficult to expand;
Unable to support high-power long-distance transmission: in 5G scenarios requiring high power supply to remote active antenna units (AAUs), the voltage drop means that transmission distance is limited.

Therefore, improved power consumption management of RAN nodes is needed.

### SUMMARY

According to a first aspect of the present disclosure, a method at a first RAN node for managing power consumption of a second RAN node is provided. The method comprises: determining whether one or more first conditions related to a traffic load of the second RAN node are fulfilled or not; and transmitting, to the second RAN node, a first message for requesting the second RAN node to operate in a first state with less frequency resource than that previously configured for the second RAN node in response to determining that the one or more first conditions are fulfilled.

In some embodiments, the method further comprises: determining whether one or more second conditions related to the second RAN node are fulfilled or not; and transmitting, to the second RAN node, a second message for requesting the second RAN node to operate in a second state with the previously configured frequency resource in response to determining that the one or more second conditions are fulfilled. In some embodiments, the method further comprises: determining whether one or more third conditions related to the second RAN node are fulfilled or not; and transmitting, to the second RAN node, a third message for requesting the second RAN node to operate in a third state with a newly configured frequency resource in response to determining that the one or more third conditions are fulfilled. In some embodiments, the one or more first conditions comprise at least one of: whether a current Physical Resource Block (PRB) load is lower than a configurable threshold; and whether a predicted traffic load will be lower than a configurable threshold for a configurable time period. In some embodiments, the one or more second conditions and/or the one or more third conditions comprise at least one of: whether a current PRB load is higher than a configurable threshold; and whether a predicted traffic load will not be lower than a configurable threshold for a configurable time period.

In some embodiments, the predicted traffic load is predicted by a data-driven Artificial Intelligence (AI) algorithm. In some embodiments, the first message indicates at least one of: a reduced carrier bandwidth; a duration for the reduced carrier bandwidth; a reduced PRB usage; and a duration for the reduced PRB usage. In some embodiments, a reduced carrier bandwidth and/or a reduced PRB usage is indicated by a ratio of a previously configured carrier bandwidth and/or a ratio of a previously configured number of PRBs, respectively. In some embodiments, the first message is a message scheduling transmission from/to the second RAN node with a reduced number of PRBs and/or with a reduced carrier bandwidth. In some embodiments, the reduced number of PRBs and/or reduced carrier bandwidth are achieved by allocating a reduced number of continuous or discontinuous frequency resources. In some embodiments, the third message indicates at least one of: a carrier bandwidth configured for the second RAN node; and a number of PRBs configured for the second RAN node.

In some embodiments, at least one of the first message, the second message, and the third message is one of: a Transmit Receive-Device Control Interface (TR-DCI) message that is transmitted via a Common Access Tier (CAT) interface; an In-phase Quadrature (IQ) control message that is transmitted via a Common IQ control path (IQC) interface; an IQ control message that is transmitted via a Common Public Radio Interface (CPRI) or an evolved CPRI (eCPRI) interface; and a message that is transmitted via open fronthaul interface—Management plane (M-Plane) or Control plane (C-Plane). In some embodiments, the first RAN node is a Digital Unit (DU), and the second RAN node is a Radio Unit (RU). In some embodiments, the first RAN node is a cloud RAN Central Unit (CU), and the second RAN node is an RU. In some embodiments, the first RAN node is a Baseband Unit (BBU), and the second RAN node is an RU. In some embodiments, the first RAN node is an ORAN Distributed Unit (O-DU), and the second RAN node is an ORAN Radio Unit (O-RU).

According to a second aspect of the present disclosure, a first RAN node is provided. The first RAN node comprises: a processor; a memory storing instructions which, when executed by the processor, cause the processor to perform the method of any of the first aspect.

According to a third aspect of the present disclosure, a method at a second RAN node for managing power consumption is provided. The method comprises: receiving, from a first RAN node, a first message for requesting the second RAN node to operate in a first state with less frequency resource that that previously configured for the second RAN node; and adjusting at least one of device components of the second RAN node at least partially based on the first message, such that the second RAN node is operated in the first state.

In some embodiments, the method further comprises: receiving, from the first RAN node, a second message for requesting the second RAN node to operate in a second state with the previously configured frequency resource; and adjusting at least one of device components of the second RAN node at least partially based on the second message, such that the second RAN node is operated in the second state. In some embodiments, the method further comprises: receiving, from the first RAN node, a third message for requesting the second RAN node to operate in a third state with a newly configured frequency resource; and adjusting at least one of device components of the second RAN node at least partially based on the third message, such that the second RAN node is operated in the third state.

In some embodiments, the first message indicates at least one of: a reduced carrier bandwidth; a duration for the reduced carrier bandwidth; a reduced PRB usage; and a duration for the reduced PRB usage. In some embodiments, a reduced carrier bandwidth and/or a reduced PRB usage is indicated by a ratio of previously configured carrier bandwidth and/or a ratio of a previously configured number of PRBs, respectively. In some embodiments, the third message indicates at least one of: a carrier bandwidth configured for the second RAN node; and a number of PRBs configured for the second RAN node.

In some embodiments, at least one of the first message, the second message, and the third message is one of: a TR-DCI message that is transmitted via a CAT interface; an IQ control message that is transmitted via a IQC interface; an IQ control message that is transmitted via an CPRI or eCPRI interface; and a message that is transmitted via open fronthaul interface—M-Plane or C-Plane.

In some embodiments, the step of adjusting at least one of device components of the second RAN node at least partially based on the first message comprises at least one of: deactivating at least one of the device components; lowering a sampling rate of at least one filter; lowering operation drain voltage for at least one power amplifier; and lowering CFR threshold of radio unit accordingly. In some embodiments, the step of adjusting at least one of device components of the second RAN node at least partially based on the second message comprises at least one of: scheduling transmission from/to the second RAN node with a previously configured number of PRBs; scheduling transmission from/to the second RAN node with a previously configured carrier bandwidth; activating at least one of the device components; restoring at least one filter with a previously configured sampling rate; restoring at least one power amplifier with a previously configured operation drain voltage; and restoring CFR threshold of radio unit accordingly.

In some embodiments, the step of adjusting at least one of device components of the second RAN node at least partially based on the third message comprises at least one of: scheduling transmission from/to the second RAN node with a newly configured number of PRBs; scheduling transmission from/to the second RAN node with a newly configured carrier bandwidth; activating at least one of the device components; operating at least one filter with a newly configured sampling rate; supplying at least one power amplifier with a newly configured operation drain voltage; and adjusting Crest Factor Reduction (CFR) threshold of radio unit accordingly

In some embodiments, the device components comprise at least one of: one or more Beamforming (BF) components; one or more digital filters; one or more TRX transceivers; and one or more PAs. In some embodiments, the first RAN node is a DU, and the second RAN node is an RU. In some embodiments, the first RAN node is a cloud RAN CU, and the second RAN node is an RU. In some embodiments, the first RAN node is a BBU, and the second RAN node is an RU. In some embodiments, the first RAN node is an O-DU, and the second RAN node is an O-RU.

According to a fourth aspect of the present disclosure, a second RAN node is provided. The second RAN node comprises: a processor; a memory storing instructions which, when executed by the processor, cause the processor to perform the method of any of the third aspect.

According to a fifth aspect of the present disclosure, a network node is provided. The network node comprises: a first RAN node of the second aspect and one or more second RAN nodes of the fourth aspect.

According to a sixth aspect of the present disclosure, a computer program comprising instructions is provided. The instructions, when executed by at least one processor, cause the at least one processor to carry out the method of the first aspect and/or the third aspect.

According to a seventh aspect of the present disclosure, a carrier containing the computer program of the sixth aspect is provided. The carrier is one of an electronic signal, optical signal, radio signal, or computer readable storage medium.

### BRIEF DESCRIPTION OF THE DRAWINGS

FIG. 1 is a diagram illustrating an exemplary RAN in which power consumption management according to an embodiment of the present disclosure may be applicable.

FIG. 2 is a diagram illustrating exemplary protocol stacks for a DU and an RU according to an embodiment of the present disclosure.

FIG. 3 is a diagram illustrating an exemplary flexible resource configuration according to an embodiment of the present disclosure.

FIG. 4 is diagram illustrating a comparison of energy conserving inside an RU according to an embodiment of the present disclosure.

FIG. 5 is a diagram illustrating an exemplary power consumption management in frequency domain according to an embodiment of the present disclosure.

FIG. 6 is a diagram illustrating an exemplary power consumption management in time domain according to an embodiment of the present disclosure.

FIG. 7 is a diagram illustrating exemplary procedures for managing power consumption of a RAN node according to an embodiment of the present disclosure.

FIG. 8A to FIG. 8C are diagrams illustrating exemplary power consumption management in various domains according to an embodiment of the present disclosure.

FIG. 9 is a diagram illustrating exemplary methods for slow control and fast control of power consumption according to an embodiment of the present disclosure.

FIG. 10 is a diagram illustrating another exemplary RAN in which power consumption management according to another embodiment of the present disclosure may be applicable.

FIG. 11 is a diagram illustrating exemplary procedures for managing power consumption of a RAN node according to another embodiment of the present disclosure.

FIG. 12 is a diagram illustrating exemplary procedures for managing power consumption of an O-RAN node according to yet another embodiment of the present disclosure.

FIG. 13 is a flow chart illustrating an exemplary method at a first RAN node for managing power consumption of a second RAN node according to an embodiment of the present disclosure.

FIG. 14 is a flow chart illustrating an exemplary method at a second RAN node for managing power consumption according to an embodiment of the present disclosure.

FIG. 15 schematically shows an embodiment of an arrangement which may be used in a first RAN node or a second RAN node for power consumption management according to an embodiment of the present disclosure.

FIG. 16 is a block diagram of an exemplary first RAN node for managing power consumption of a second RAN node according to an embodiment of the present disclosure.

FIG. 17 is a block diagram of an exemplary second RAN node for managing power consumption according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as power consumption management is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, etc.

Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “network node” used herein may refer to a network function, a network element, a RAN node, an OAM node, a testing network function, a transmission reception point (TRP), a base station, a base transceiver station, an access point, a hot spot, a NodeB, an Evolved NodeB (eNB), a gNB, a network element, or any other equivalents. Further, please note that the term “indicator” used herein may refer to a parameter, a coefficient, an attribute, a property, a setting, a configuration, a profile, an identifier, a field, one or more bits/octets, an information element, or any data by which information of interest may be indicated directly or indirectly.

Further, the abbreviation “DU” used herein may refer to “Digital Unit” in most of the cases. However, in rest of the cases, the abbreviation “DU” may refer to “Distributed Unit”, especially when used in relation to with “Central Unit” or “CU” or when used in “O-DU”.

As mentioned above, the large power consumption of 5G RAN node becomes one of most essential blocking issues for operators to deploy more 5G networks. A lot of analysis shows this trend on the base station (BS) perspective under 3GPP or O-RAN protocols. On the other hand, low traffic is more typical in current real network and full BS capacity is not needed when traffic is relatively low. This provides opportunities for EE (Energy Efficiency) functionalities development.

While more and more EE functionalities have been implemented and have achieved remarkable effect, there is a general lack of EE functionalities to consider frequency domain or both frequency domain and time domain. Less negative impact for network Key Performance Indicator (KPI) would be produced while doing energy conserving in the frequency domain. Therefore, some embodiments of the present disclosure propose a method with flexible resource configuration, aiming to reduce power consumption on BS while power consumption on UE side is not increased. It also delivers more chances for further EE feature development.

In 4G LTE, the transmission is fixed to system carrier bandwidth and there is not much flexibility to adjust carrier bandwidth or scheduling resource in frequency domain (e.g., in terms of PRB) based on current network condition.

In 5G NR, the concept “Bandwidth Part (BWP)” is proposed to reduce UE power consumption. The corresponding methods give a flexibility to change transmission bandwidth according to UE transient traffic load and channel condition. UE can reduce time to monitor larger bandwidth and thus reduce power consumption. However, it cannot provide similar benefit for BS because UE does not know traffic condition for the whole cell and can only configure BWP based on its own requirement. Furthermore, for each UE, only one of 4 configured BWPs can be used after initiation in current NR Rel-16 which does not provide enough flexibility for BS to adjust bandwidth according to its power consumption condition.

Symbol based power saving (SBPS) may be implemented to turn off a power amplifier (PA) when there is no data transmission, but this feature is a power saving method in time domain only. The frequency domain utilization is quite relevant to PA efficiency which also impact on the final power consumption result. Solution of Low Energy Scheduler Solution (LESS) in time domain tries to get the maximum frequency utilization for a fixed bandwidth and reserve blank symbols as much as possible, thereby saving power based on SBPS function. However, it may cause long delay for some data by trying to achieve a very high frequency utilization, and this is unacceptable for 5G operators mostly due to their strict limits on system latency. In that case, both SBPS and LESS cannot achieve a good balance between latency and frequency domain utilization, thus the optimized results is typically not discovered based on them only.

On the other hand, in addition to BS energy-saving, the optimization of carrier configuration of network, such as flexible carrier reconfiguration, flexible bandwidth change, bandwidth (or spectrum resource) sharing and so on, can also be realized. Compared with the traditional cell-sleep when traffic load is not high, it is easier for the solution according to some embodiments of the present disclosure to do real-time scaling, and therefore this is another advantage.

Further, for O-RAN ecosystem, obviously there is no power saving relevant concept or method defined yet, so it is necessary to consider this issue and adding such kind of method as well.

Some embodiments of the present disclosure may flexibly adjust occupied PRBs or even smaller granularity without bandwidth changing, or directly change carrier practical bandwidth for BS transmission according to the whole cell traffic load (PRB load or usage is another way of saying). In some embodiments, the adjustment can be configured by higher layer parameters, DCI (Device control interface) or other configuration methods. In some embodiments, the adjustment can be configured by BBL1 (baseband Layer 1) to control resource blocks from frequency domain and time domain for quick switching scenario. In some embodiments, the corresponding message may be transferred to radio for triggering EE functionalities.

Radio can increase or reduce power class of PA semi-statically or dynamically based on the adjustment of occupied PRBs and carrier practical bandwidth. Further, the power class adjustment may impact on supply voltage (VDD) of PA and then impact on total power consumption of radio. In some embodiments, different device components could be switched off for different lasting time, for example Digital Front End (DFE) and Low-PHY. In some embodiments, data bus speed and sampling rate could be optimized when carrier bandwidth or PRB number is restricted.

Furthermore, restricted PRBs or bandwidth could be continuous or discontinuous. This is important because more headroom (or margin) for BBL1 scheduler and higher tiers (L2, L3, OAM layer) may be reserved.

In some embodiments, new signaling message from DU (Digital unit) to RU (Radio unit) may be defined for initiating the flexible changing of PRB occupation or carrier bandwidth based on whole cell traffic load. In some embodiments, some basic adjustment rules may comprise at least one of:
the unit of adjustment is not limited as PRB or even smaller granularity or carrier bandwidth;
according to PRB load and channel quality indicator even BWP information from UE or other necessary parameters (base on specific scheduler of BBL1).

In some embodiments, a new mechanism may be provided to optimize power class, PA VDD, related sampling rate, and/or minimum power consumption of RU based on PRB number or bandwidth changing and lasting time.

With these embodiments, one or more of following benefits may be provided:
flexibility may be provided for BS to reduce power consumption initiatively based on whole cell traffic load;
the best solution may be provided, for example, based on both frequency and time domain utilization;
bandwidth adjustment could be very flexible according to requirement and protocol evolution;
the solution could be used in O-RAN to reduce RU power consumption since there is no relevant concept or method definition in O-RAN protocol;
relatively low KPI (Accessibility, Mobility related, system latency and throughput etc.) impact when cell traffic load is not FULL (the lower the better);
the network organizing may become flexible and automatic, e.g., similar to carrier reconfiguration, bandwidth (spectrum resource) sharing;
a wide application range and possibility may be achieved, because there are more than one option for flexible bandwidth power saving, quick adjustment from BBL1 scheduler and slow adjustment from higher tiers; and
signaling interaction over Fronthaul may be obviously reduced.

For example, in time domain, device components can be turned off or placed into the sleep mode when no data transmission in a symbol, slot, or other longer durations. For another example, in frequency domain, bandwidth and relative radio resources in frequency domain can be reduced, limited, or shutdown (disabled) during low traffic loads.

Currently, there are a lot of RAN architectures proposed, for example, Distributed RAN (D-RAN), Centralized RAN/Cloud RAN (C-RAN), Virtual RAN (vRAN), or Open RAN (O-RAN), or the like.

In D-RAN, RU/RRU and BBU may be co-located at every cell site. Each cell site with all its radio functions are distributed and connected back to the core network through backhaul. In C-RAN, the BBU moves to a centralized location and the cell site only has the antenna and the RU/RRU, resulting a new interface called Fronthaul between BBU and RU/RRU. This centralization of BBU functionality (also called BBU pool) results in the name C-RAN. In addition, a second option of the C-RAN architecture has a further split in BBUs into Distributed Unit (DU) and Central Unit (CU). Here, CU is further towards the core network resulting in a new interface called midhaul between DU and CU.

vRAN decouples the software from hardware by virtualizing network functions. It uses virtualization technologies such as Network Function Virtualization (NFV) or containers to deploy CU and DU over Commercial Off-The-Shelf (COTS) servers. Therefore, there is no substantial difference between vRAN and C-RAN except that traditionally C-RAN uses proprietary hardware while vRAN uses network functions on a server platform.

O-RAN takes vRAN to the next level. While traditionally vRAN is a closed network, as RU, DU, and CU, which are all part of the RAN must be bought from the same vendor. The O-RAN is working on specifications to open the interface between RU/RRU and DU and further between DU and CU. This means that a customer can mix and match the components from different vendors without being locked to one vendor for all these three components, thus resulting in an open RAN network.

Please note that although some embodiments will be described below in the context of one or more of the RAN architectures, the present disclosure is not limited thereto. In fact, the power consumption management according to some embodiments of the present disclosure may also be applicable to other RAN architectures than those described hereinafter.

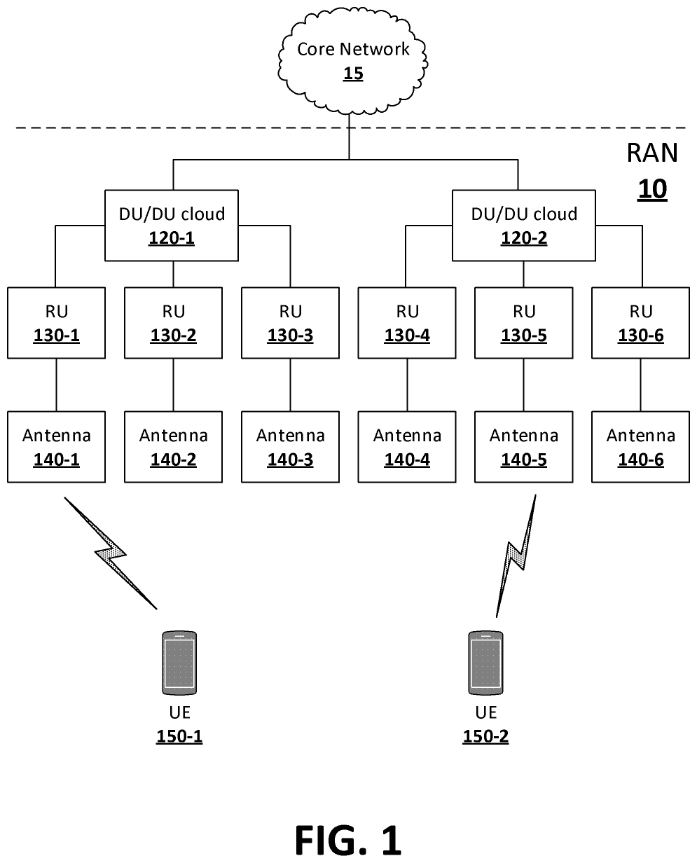

FIG. 1 is a diagram illustrating an exemplary RAN 10 in which power consumption management according to an embodiment of the present disclosure may be applicable. As shown in FIG. 1, the RAN 10 may comprise one or more Digital Units (DUs)/DU clouds 120-1 and 120-2 (hereinafter, also collectively referred to as DU 120), one or more Radio Units (RUs) 130-1 through 130-6 (hereinafter, also collectively referred to as RU 130), and one or more antennas 140-1 through 140-6 (hereinafter, also collectively referred to as antenna 140). Further, one or more UEs 150-1 and 150-2 (hereinafter, also collectively referred to as UE 150) may wirelessly access the RAN 10 as shown in FIG. 1, such that they can communicate with a Core Network (CN) 105, and then further with other networks, such as the Internet.

The DU/DU clouds 120 are so named because most of digital signal processing tasks for radio access are performed at the DU/DU cloud 120. In some embodiments, the DU 120 may be sometimes referred to as BBU, which may be centralized in one physical location for providing resource aggregation and pooling, and therefore the DU cloud 120 may be sometimes referred to as BBU pool. In some embodiments, the DU clouds 120 may be composed of many identical DUs interconnected together. They may provide the capacity to aggregate the processing power of DUs together and allocate the processing powers to real-time tasks of BS according to network load. Please note that, depending on the function split between BBU and RU/RRU, a BBU may be a Digital Unit (DU) in some cases while may not be a DU in other cases. Further, different Radio Access Technologies (RATs) can be implemented on a same RAN physical system.

In some embodiments, the RUs 130 are in charge of the radio functions from RF transmission and reception to digital baseband and adaptation to the transport network. The RUs 130 may perform RF amplification, up/down conversion, filtering, A/D and D/A conversion, and/or interface adaptation. The RUs 130 may connect via optical transport networks to one or more DU clouds 120 or to other RUs (e.g., via daisy chaining).

As also shown in FIG. 1, the DU 120-1 and the DU 120-2 may be communicatively coupled to three RUs 130-1, 130-2, 130-3 and three RUs 130-4, 130-5, 130-6, respectively. Further, each of RUs 130 may be communicatively coupled to one of the antennas 140. Although specific numbers of DUs/RUs/antennas/UEs and specific connections are shown in FIG. 1, the present disclosure is not limited thereto. In some other embodiments, any number of these entities may be present in a RAN, for example, based on the RAN operator's requirements and/or other factors. In some other embodiments, more connections, less connections, different connections may be present between the DUs/RUs/antennas/UEs.

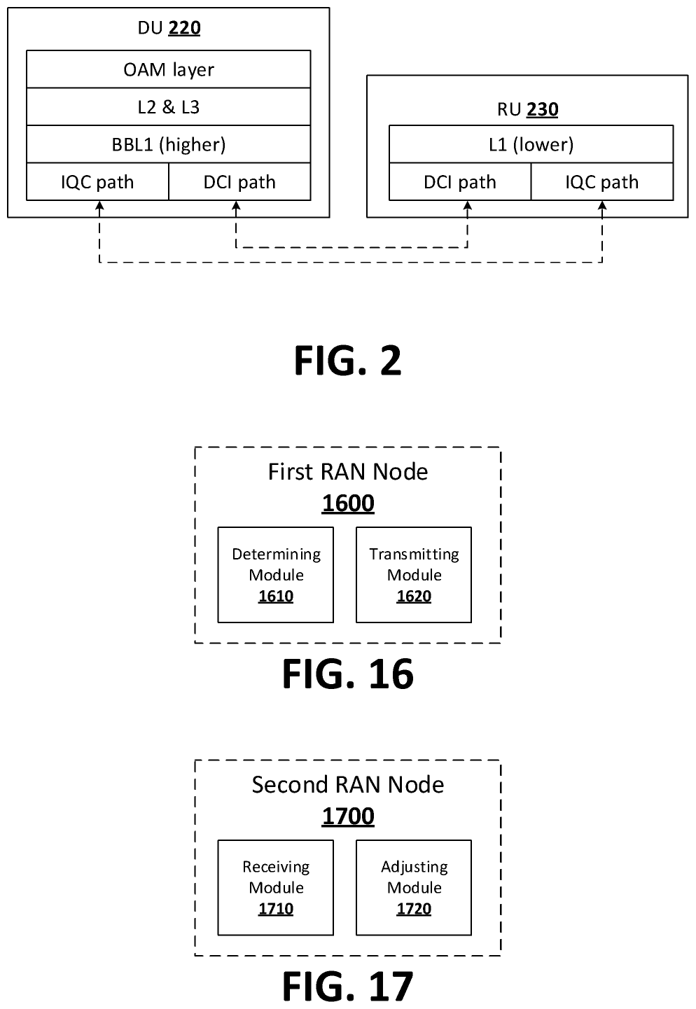

FIG. 2 is a diagram illustrating exemplary protocol stacks for a DU 220 and an RU 230 according to an embodiment of the present disclosure. In some embodiments, the DU 220 may run the radio link control (RLC) and medium access control (MAC) layers in addition to a higher part of the physical layer (PHY) at a base station (BS) site. In some embodiments, the DU 220 may further run the radio resource control (RRC) protocol, which conducts many functions, including information broadcasting, establishing and releasing connections between UEs (e.g., the UEs 150) and RAN (e.g., the RAN 10), and controlling the quality of service. The DU 220 may also work with the packet data convergence protocol (PDCP), which may compress and decompress IP data stream headers and transfers user data, among other technical functions. In other words, the DU 220 may run Baseband L1 (BBL1, that is, the higher part of PHY or high PHY), L2 (e.g., MAC, RLC, PDCP), L3 (e.g., RRC), and Operation and Maintenance (OAM) layers, as shown in FIG. 2. In some embodiments, the RUs 130 may run a lower part of the PHY layer (or low PHY), as also shown FIG. 2, and they may control the corresponding antennas to transmit and/or receive signals to and/or from the UEs 150.

Further, there are one or more paths for control signalling between the DU 220 and the RU 230. As shown in FIG. 2, an IQC path and/or a DCI path are provided for control signalling, which will be described later with reference to FIG. 9. However, the present disclosure is not limited thereto. In some other embodiments, one or more paths other than those described herein may be used.

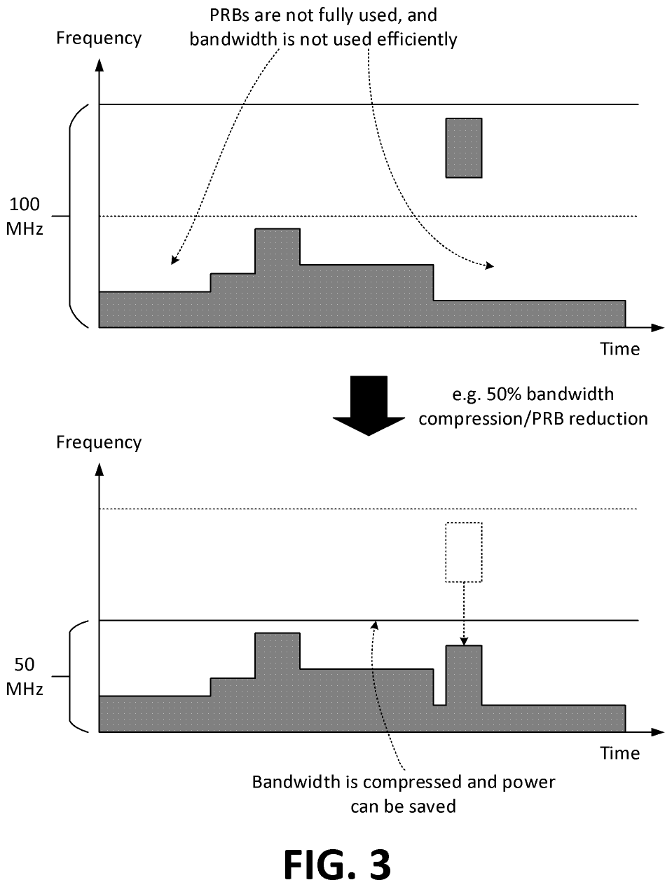

FIG. 3 is a diagram illustrating an exemplary flexible resource configuration according to an embodiment of the present disclosure. As shown in FIG. 3, when a DU decides final scheduled PRB or carrier bandwidth occupation according to cell traffic load and corresponding pattern, it may transmit a message to one or more corresponding RUs to trigger EE functionalities (for example, bandwidth compression/PRB reduction as shown in FIG. 3). With the EE functionality enabled, power consumption at the RUs may be reduced.

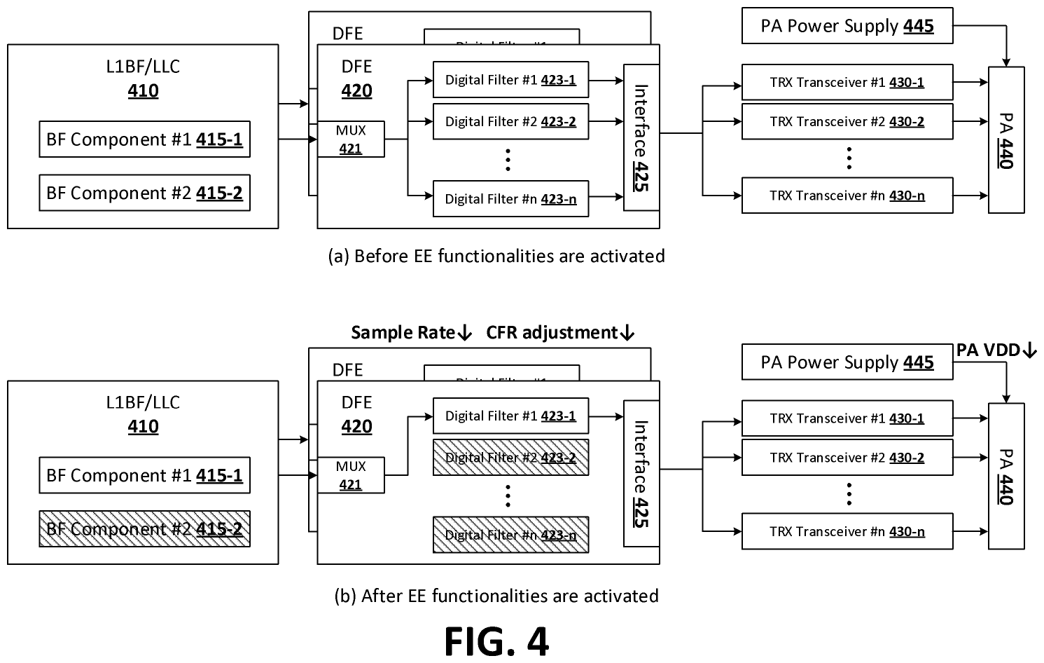

To achieve such a solution, a new message interface may be defined between the DU and the RU to transfer scheduled PRB or bandwidth information. Further, some new EE approaches and/or functionalities in the RU based on scheduled bandwidth and lasting time information may be implemented accordingly (for example, those shown in FIG. 4).

FIG. 4 is diagram illustrating a comparison of energy conserving inside an RU according to an embodiment of the present disclosure. This is a holistic picture of energy conserving from RU perspective. These EE functionalities implemented and to be implemented are what RU can be done to adapt various “resource” allocated by BBL1 scheduler or higher tiers. However, the present disclosure is not limited thereto.

As shown in FIG. 4, some of the device components of the RU may be turned off (e.g., a BF component #2 415-2, digital filters #2-#n 423-2 to 423-n). As also shown in FIG. 4, some of the operating parameters may be adjusted, for example, the sample rate and/or crest factor of the DFEs 420 may be lowered or reduced, and/or the PA supply voltage (PA VDD) of the PA 440 may be lowered. In this way, the power consumption of the RU may be lowered to save energy.

In some embodiments, there are two types of methods to determine whether EE functionalities shall be activated or not.

### Method 1—Configurable Thresholds

One or more thresholds may be configured to determine whether EE functionalities shall be activated or not. In some embodiments, one or more lower thresholds may be provided to determine whether one or more EE functionalities shall be activated or not. For example, when the PRB load is lower than a lower threshold (e.g. 10%), the EE functionality “flexible bandwidth” may be activated. In some embodiments, one or more upper thresholds may be provided to determine whether one or more activated EE functionalities shall be deactivated or not. For example, when the PRB load is higher than an upper threshold (e.g., 30%), the activated EE functionality “flexible bandwidth” may be deactivated.

### Method 2—AI Based Solution

A data-driven AI based algorithm may be used to predict the near future traffic load. For example, when low traffic load is detected and a predicted duration for low traffic load fulfills the requirement at the same time, one or more EE functionalities (e.g., flexible bandwidth) may be enabled. In some other embodiments, when one of the preconditions is disappeared or not satisfied, the enabled EE functionalities may be disabled then.

In some embodiments, the network KPIs may always be on the top of priority list.

In some embodiments, an exemplary definition of interfaces may be given in the following tables.

Interface type 1 (slow response, TR-DCI message)

TABLE 1

| Attribute-items | Description | Direction (DL/UL) |
|---|---|---|
| Carrier | Configuration of practical carrier | Downward effective |
| bandwidth | bandwidth from Higher tiers | |
| Lasting time | Valid time of bandwidth | Downward effective |
| | compression | |

Interface type 2 (quick response, IQ control message)

TABLE 2

| Attribute-items | Description | Direction (DL/UL) |
|---|---|---|
| PRB usage | PRB scheduling in frequency | Downward effective |
| | domain from BBL1 scheduler | |
| Lasting time | Valid time of PRB restriction | Downward effective |

In the above tables, DL means downlink or from DU to RU, while UL means uplink or from RU to DU.

Please note that, these interfaces are provided merely for the purpose of exemplification, rather than limitation.

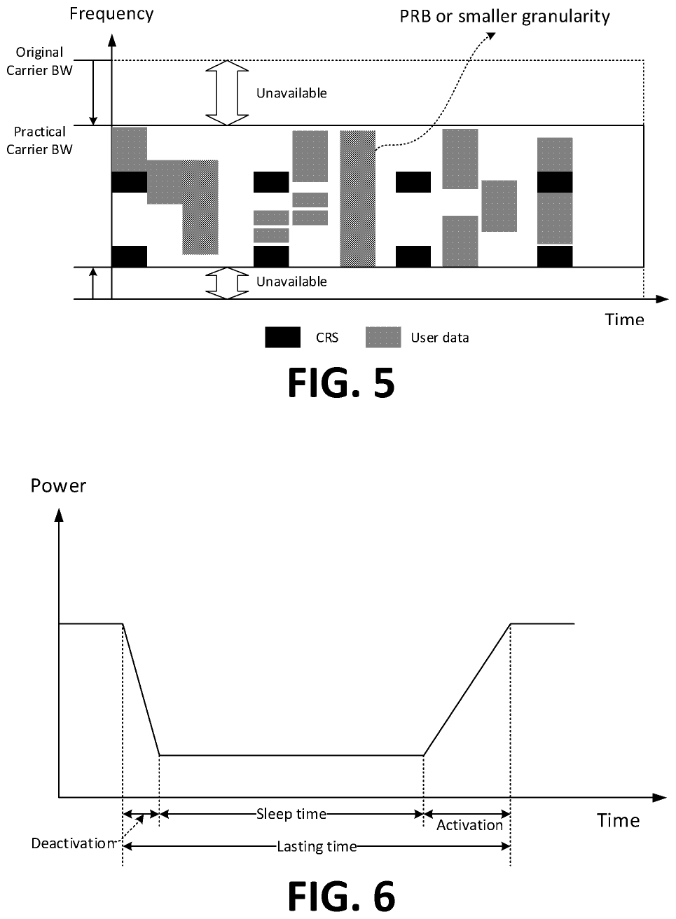

FIG. 5 is a diagram illustrating an exemplary power consumption management in frequency domain according to an embodiment of the present disclosure, and FIG. 6 is a diagram illustrating an exemplary power consumption management in time domain according to an embodiment of the present disclosure.

As shown in FIG. 5, frequency resources allocated or configured for an RU (e.g., carrier bandwidth or PRB) may be compressed or otherwise reduced, such that the RU may be operated in a state where frequency resource that is initially allocated or previously allocated may not be fully used. For example, the frequency resources indicated by “unavailable” arrows may not be used by the BS and its served UEs. Further, as also mentioned above, restricted PRBs or carrier bandwidth could be allocated continuously or discontinuously. For example, two discontinuous parts of unavailable frequency resources are shown in FIG. 5, while within each of the parts the unavailable frequency resource is continuous. However, the present disclosure is not limited thereto. In some other embodiments, another number of discontinuous parts of unavailable frequency resources may be indicated or otherwise configured for the RU.

Further, one or more parameters for power consumption management in time domain may be indicated or otherwise configured for the RU, and these parameters may comprise at least one of:
Hardware components sleeping time (e.g., the BF component #2 415-2, the digital filter #2 423-2, etc. shown in FIG. 4);
Low PA VDD running time (e.g., lowered PA VDD shown in FIG. 4);
Low sampling rate running time (e.g., lowered sampling rate shown in FIG. 4); and
More EE functionalities to be implemented.

As shown in FIG. 6, a parameter “Sleep time” indicating a low PA VDD running time may be configured for the RU. Upon reception of the parameter, the RU may begin lowering its PA's supply voltage as indicated by the phase “Deactivation”. When a desired low power level is reached, a timer may be set for the phase “Sleep time” until the timer expires. After that, the PA's supply voltage may be restored to a normal level as indicated by the phase “Activation”, and finally the PA may be operated in its normal state. The overall duration “Lasting time” for saving energy may be the sum of the durations of all three phases, “Deactivation”, “Sleep time”, and “Activation”.

However, the present disclosure is not limited thereto. In some other embodiments, more than one parameter for configuring durations of EE functionalities may be provided. For example, a pair of parameters “start time” and “end time” or “start time” and “lasting time” may be configured for the RU, such that the RU may start its EE functionalities at a specified time indicated by “start time”, rather than immediately, and this can be applicable in a scenario where low traffic is predicted to occur in the future. Further, multiple configurations may be issued from the DU to the RU separately, such that one configuration may indicate the activation of the EE functionalities, and another subsequent configuration may indicate the deactivation of the EE functionalities. This can be applicable, for example, in a scenario where the DU or any other device, which makes the decision of whether EE functionalities shall be activated or not, has no idea how long the low traffic situation will last.

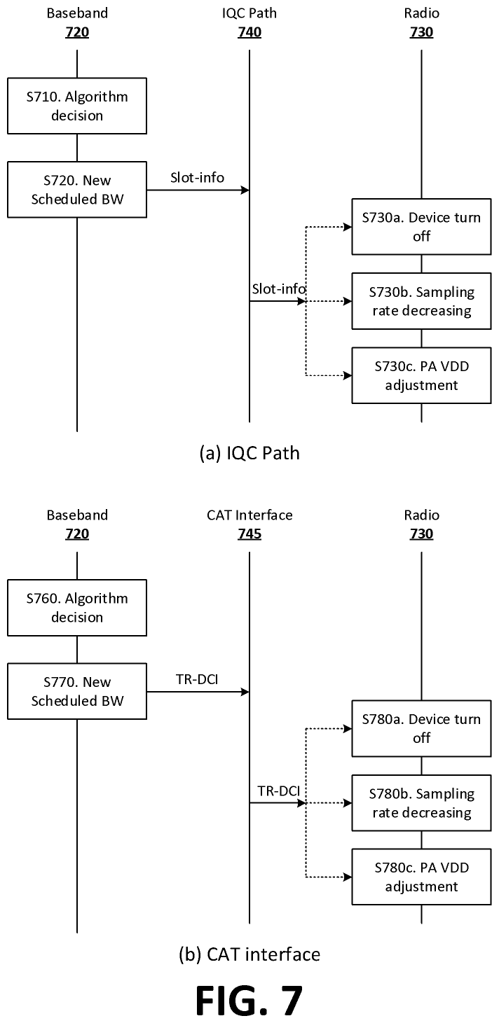

FIG. 7 is a diagram illustrating exemplary procedures for managing power consumption of a RAN node (e.g., a radio 730) according to an embodiment of the present disclosure. The procedure (a) shown in FIG. 7 may be performed via an IQC path 740 between a DU or BBU 720 and an RU or radio 730 while the procedure (b) may be performed via a Common Access Tier (CAT) interface 745 between the DU or BBU 720 and the RU 730.

The procedure (a) may start at step S710 where the DU 720 may decide whether to change occupied bandwidth, and may determine BBL1 scheduling based on the decision (e.g., a prediction from an AI based algorithm mentioned earlier).

At step S720, a new defined message may be transmitted from the DU 720 to the radio 730. As shown in (a), the message may be transferred in Slot-info (an IQ control message) via the IQC path 740. In some embodiments, the RU 730 may keep the same bandwidth but adjust scheduled resources, for example, at a PRB level or even a smaller granularity, and the message may be a ratio of scheduled resources. In some embodiments, the RU 730 may adjust bandwidth configuration, and the message may be a new bandwidth configuration.

At steps S730a/S730b/S730c, one or more EE functionalities may be activated based on the received message. For example, the message may indicate one or more of following EE functionalities:
reduce/increase/keep current power class;
impact on PA VDD;
impact on CFR threshold;
impact device components ON-OFF control;
optimized sampling rate of DFE; and
other EE functionalities.

The procedure (b) may start at step S760 where the DU 720 may decide whether to change occupied bandwidth, and may determine BBL1 scheduling based on the decision (e.g., a prediction from an AI model mentioned earlier).

At step S770, a new defined message may be transmitted from the DU 720 to the radio 730. As shown in (b), the message may be transferred in Transmit-Receive DCI via the CAT interface 745. In some embodiments, the RU 730 may keep the same bandwidth but adjust scheduled resources, for example, at a PRB level or even a smaller granularity, and the message may be a ratio of scheduled resources. In some embodiments, the RU 730 may adjust bandwidth configuration, and the message may be a new bandwidth configuration.

At steps S780a/S780b/S780c, one or more EE functionalities may be activated based on the received message. For example, the message may indicate at least one of following EE functionalities:
reduce/increase/keep current power class;
impact on PA VDD;
impact on CFR threshold;
impact device components ON-OFF control;
optimized sampling rate of DFE; and
other EE functionalities.

As mentioned earlier, EE functionalities may involve operations in frequency domain and/or time domain. Some examples may include:
Time domain: Device components can be set to OFF or Sleep mode when no data transmission in a symbol, slot, or other longer durations;
Frequency domain: Bandwidth and relative radio resources in frequency domain can be limited or shutdown (disabled) during low traffic loads.

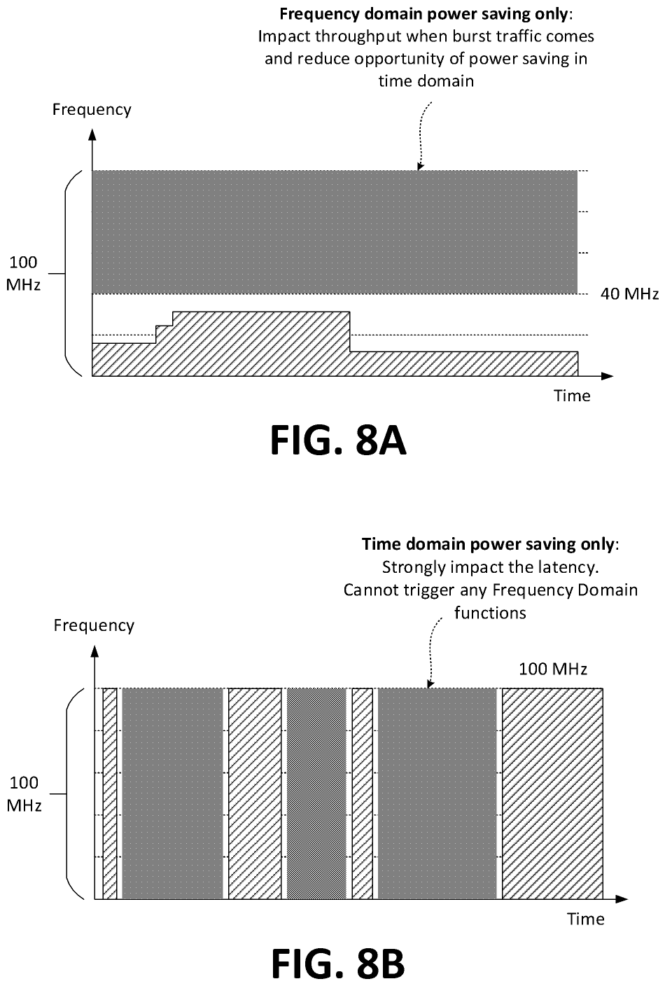

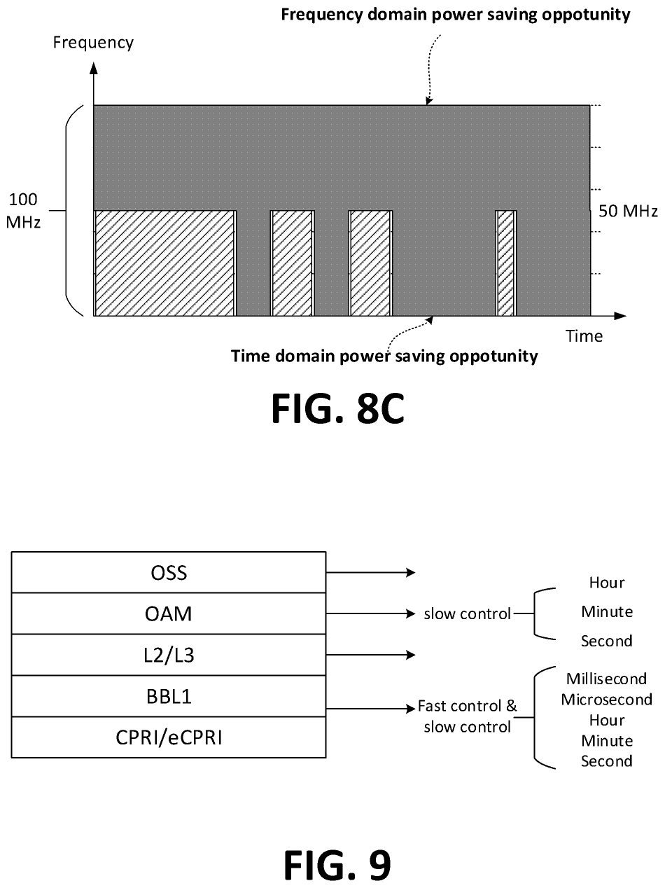

FIG. 8A to FIG. 8C are diagrams illustrating exemplary power consumption management in various domains according to an embodiment of the present disclosure. FIG. 8A involves frequency domain power saving only in which throughput is impacted when burst traffic comes and power saving opportunity in the time domain is reduced. As shown in FIG. 8A, there is few opportunity to sleep in the time domain and about 40% of the original 100 MHz bandwidth is actually used. In such a case, about 100W may be saved, while the throughput is reduced and power saving is not too much.

FIG. 8B involves time domain power saving only in which latency is strongly impacted and no frequency domain EE functions can be triggered. As shown in FIG. 8B, the LESS and SBPS functionalities are performed in the time domain and 100% of the original 100 MHz bandwidth is actually used. In such a case, about 120 W may be saved, while a longer latency is introduced.

FIG. 8C involves both frequency domain and time domain power saving in which a high possibility for frequency domain power saving is enabled while a relatively high possibility for time domain power saving is also enabled. Further, service impact (e.g., latency or the like) can be controlled or limited, and therefore a better tradeoff may be provided. As shown in FIG. 8c, about 50% of the original frequency resources are not actually used while more than 50% of the original time resources are not actually used. In such a case, about 160 W may be saved.

From the result of demonstration as shown in FIG. 8A through FIG. 8C, more power can be saved from multi-dimension power saving, which is instructive and meaningful to the energy conserving technical area.

FIG. 9 is a diagram illustrating exemplary methods for slow control and fast control of power consumption according to an embodiment of the present disclosure. In brief, fast control and slow control may be considered for real flexibility and higher utilization rate might be improved at site if they are implemented. After all, “kilowatts hour (kwh)” is the ultimate site goal for all operators in the world.

Further, “slow control vs. fast control” could be a controversial topic because it depends on how to define fast and slow. It means which transport channel and message/signal shall be selected and used (e.g., IQ control message via IQC path or TRDCI message via OM path). This is why it is really important to plan it ahead.

As shown in FIG. 9, a fast control could be provided by BBL1 layer via a CPRI/eCPRI interface together with a slow control. With the fast and slow control, the EE functionalities can be controlled in terms of millisecond, microsecond, second, minute, or hour, for example. Further, a slow control could be provided by one or more of OSS, OAM, and L2/L3 layers via a CPRI/eCPRI interface. Compared with the control provided by BBL1 layer, the EE functionalities can be controlled with the slow control in terms of second, minute, or hour, for example.

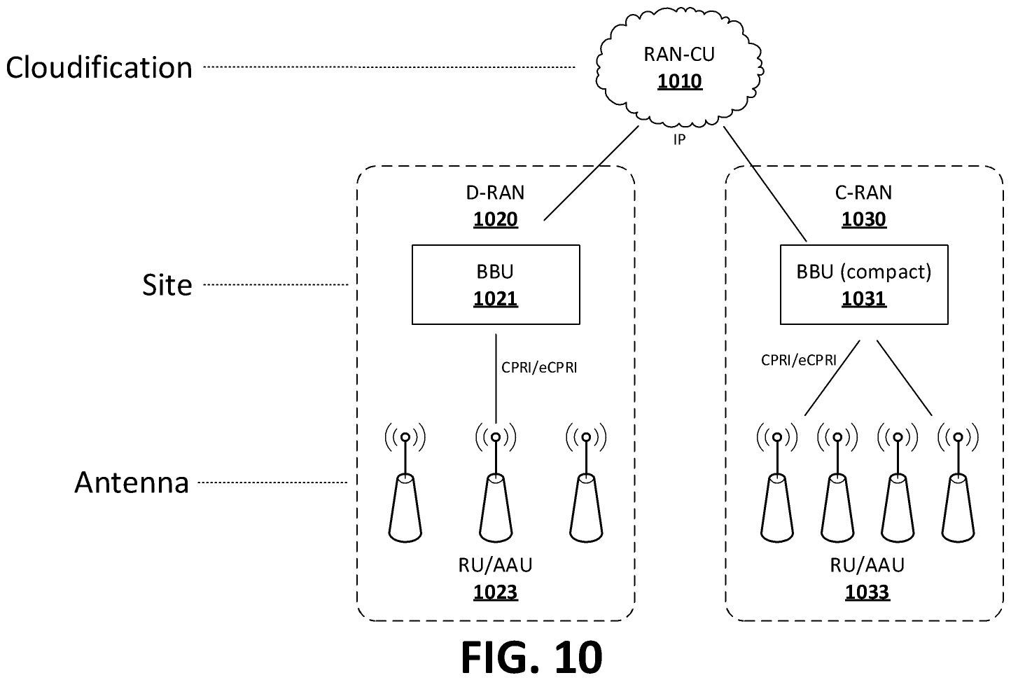

Although the above embodiments are described with reference to a specific RAN architecture shown in FIG. 1, the present disclosure is not limited thereto, as also mentioned above. The application of the power consumption management in some other RAN architectures will be described with reference to FIG. 10 through FIG. 12 below.

FIG. 10 is a diagram illustrating another exemplary RAN in which power consumption management according to another embodiment of the present disclosure may be applicable. As shown in FIG. 10, the RAN may comprise a RAN-CU 1010, one or more BBUs 1021, 1031, and one or more RU/AAU 1023, 1033. In some embodiments, the RAN-CU 1010 may be a centralized or cloudificated unit in terms of common functions (e.g., non-real time processing) for multiple cell sites. For example, the RAN- CU 1010 may serve two RANs, a D-RAN 1020 and a C-RAN 1030, and some common functions between these two RANs may be centralized or cloudificated at the RAN-CU 1010. For other entities, they may be similar to those described above, and therefore a detailed description thereof may be omitted for simplicity and clarity.

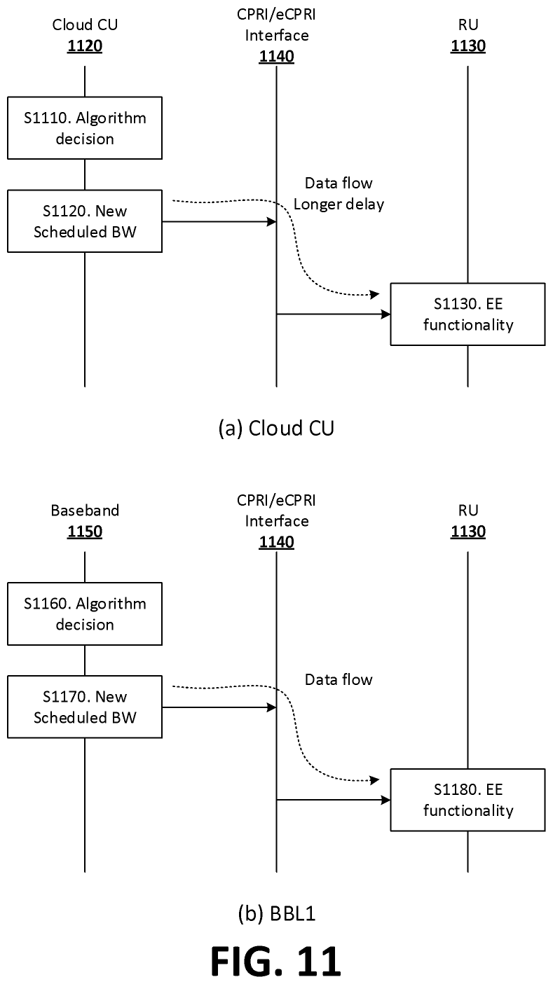

FIG. 11 is a diagram illustrating exemplary procedures for managing power consumption of a RAN node (e.g., an RU 1130) according to another embodiment of the present disclosure. The procedure (a) in FIG. 11 may start at step S1110 where a Cloud CU 1120 (e.g., the Cloud CU 1010 shown in FIG. 10) may decide whether to change occupied bandwidth, and may determine BBL1 scheduling based on the decision (e.g., a prediction from an AI algorithm mentioned earlier).

At step S1120, a message may be transmitted from the Cloud CU 1120 to the RU 1130 (e.g., the RU/AAU 1023 or 1033). As shown in (a), the message may be transferred via the CPRI/eCPRI interface.

At steps S1130, one or more EE functionalities may be activated based on the received message.

The procedure (b) is substantially similar to the procedure (a) with the exception that it is the BBU 1150 (e.g., the BBU 1021 or 1031 shown in FIG. 10) that initiates the procedure (b). Therefore, a detailed description thereof is omitted for simplicity and clarity.

Similarly, the message transmitted from the cloud CU 1120 to the RU 1130 may be considered as a slow control when compared with the message transmitted from the BBU 1150 which may be considered as a fast control since the BBU 1150 may issue a BBL1 message which is much faster than the higher layer signaling from the cloud CU 1120.

Please note that although the power consumption management according to some embodiments can also be deployed in Cloud RAN (or virtual RAN), power saving effectiveness may be reduced a bit due to unavoidable nodal process delay than traditional dedicated Hardware (especially for carrier bandwidth scaling from higher tiers, such as the cloud CU 1120). However, with regard to the long sleeping case, there is no discernible effect.

Further, as mentioned above, for O-RAN ecosystem, obviously there is no power saving relevant method and interactive interface between O-DU and O-RU defined yet, especially for EE functionalities in frequency domain. Therefore, it is necessary to consider this and adding such kind of method as well.

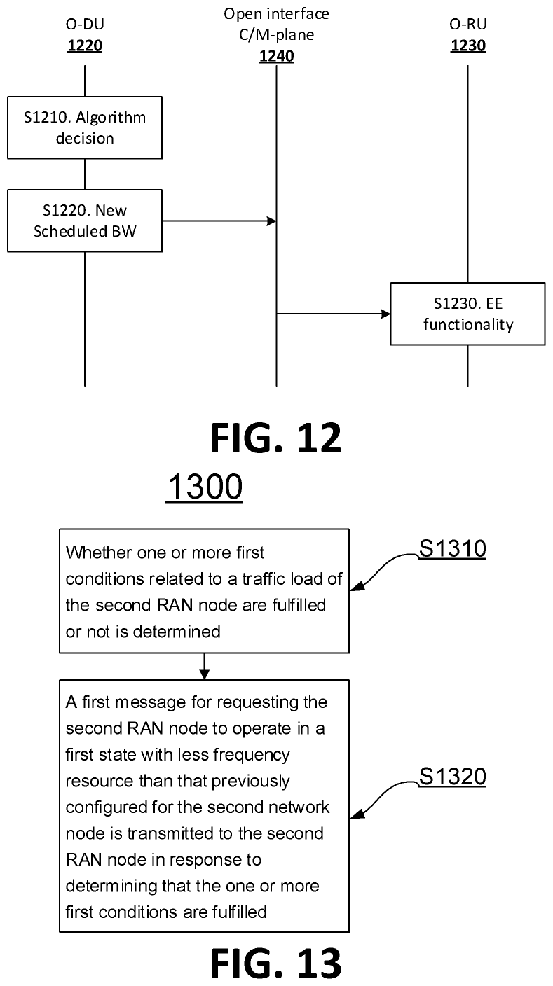

FIG. 12 is a diagram illustrating exemplary procedures for managing power consumption of an O-RAN node according to yet another embodiment of the present disclosure. As noted, the procedure shown in FIG. 12 is also substantially similar to the procedures shown in FIG. 7 and FIG. 11 with the exceptions that it is the O-DU 1220 to initiate the procedure and it is the O-RU 1230 to perform the EE functionalities and that the messages are exchanged therebetween via an Open interface C/M-plane 1240. Therefore, a detailed description thereof is omitted for simplicity and clarity.

With these embodiments described above, one or more of following benefits may be provided:
flexibility may be provided for BS to reduce power consumption initiatively based on whole cell traffic load;
the best solution may be provided, for example, based on both frequency and time domain utilization;
bandwidth adjustment could be very flexible according to requirement and protocol evolution;
the solution could be used in O-RAN to reduce RU power consumption since there is no relevant concept or method definition in O-RAN protocol;
relatively low KPI (Accessibility, Mobility related, system latency and throughput etc.) impact when cell traffic load is not FULL (the lower the better);
the network organizing may become flexible and automatic, e.g., similar to carrier reconfiguration, bandwidth (spectrum resource) sharing;
a wide application range and possibility may be achieved, because there are more than one option for flexible bandwidth power saving, quick adjustment from BBL1 scheduler and slow adjustment from higher tiers; and
signaling interaction over Fronthaul may be obviously reduced.

FIG. 13 is a flow chart of an exemplary method 1300 at a first RAN node for managing power consumption of a second RAN node according to an embodiment of the present disclosure. The method 1300 may be performed at a first RAN node (e.g., the DU 220). The method 1300 may comprise steps S1310 and S1320. However, the present disclosure is not limited thereto. In some other embodiments, the method 1300 may comprise more steps, less steps, different steps, or any combination thereof. Further the steps of the method 1300 may be performed in a different order than that described herein when multiple steps are involved. Further, in some embodiments, a step in the method 1300 may be split into multiple sub-steps and performed by different entities, and/or multiple steps in the method 1300 may be combined into a single step.

The method 1300 may begin at step S1310 where whether one or more first conditions related to a traffic load of the second RAN node are fulfilled or not may be determined.

At step S1320, a first message for requesting the second RAN node to operate in a first state with less frequency resource than that previously configured for the second RAN node may be transmitted to the second RAN node in response to determining that the one or more first conditions are fulfilled.

In some embodiments, the method 1300 may further comprise: determining whether one or more second conditions related to the second RAN node are fulfilled or not; and transmitting, to the second RAN node, a second message for requesting the second RAN node to operate in a second state with the previously configured frequency resource in response to determining that the one or more second conditions are fulfilled. In some embodiments, the method 1300 may further comprise: determining whether one or more third conditions related to the second RAN node are fulfilled or not; and transmitting, to the second RAN node, a third message for requesting the second RAN node to operate in a third state with a newly configured frequency resource in response to determining that the one or more third conditions are fulfilled. In some embodiments, the one or more first conditions may comprise at least one of: whether a current PRB load is lower than a configurable threshold; and whether a predicted traffic load will be lower than a configurable threshold for a configurable time period. In some embodiments, the one or more second conditions and/or the one or more third conditions may comprise at least one of: whether a current PRB load is higher than a configurable threshold; and whether a predicted traffic load will not be lower than a configurable threshold for a configurable time period.

In some embodiments, the predicted traffic load may be predicted by a data-driven AI algorithm. In some embodiments, the first message may indicate at least one of: a reduced carrier bandwidth; a duration for the reduced carrier bandwidth; a reduced PRB usage; and a duration for the reduced PRB usage. In some embodiments, a reduced carrier bandwidth and/or a reduced PRB usage may be indicated by a ratio of a previously configured carrier bandwidth and/or a ratio of a previously configured number of PRBs, respectively. In some embodiments, the first message may be a message scheduling transmission from/to the second RAN node with a reduced number of PRBs and/or with a reduced carrier bandwidth. In some embodiments, the reduced number of PRBs and/or reduced carrier bandwidth may be achieved by allocating a reduced number of continuous or discontinuous frequency resources. In some embodiments, the third message may indicate at least one of: a carrier bandwidth configured for the second RAN node; and a number of PRBs configured for the second RAN node.

In some embodiments, at least one of the first message, the second message, and the third message may be one of: a TR-DCI message that is transmitted via a CAT interface; an IQ control message that is transmitted via a Common IQ control path; an IQ control message that is transmitted via a CPRI or an eCPRI interface; and a message that is transmitted via open fronthaul interface—M-Plane or C-Plane. In some embodiments, the first RAN node may be a DU, and the second RAN node may be an RU. In some embodiments, the first RAN node may be a cloud RAN CU, and the second RAN node may be an RU. In some embodiments, the first RAN node may be a BBU, and the second RAN node may be an RU. In some embodiments, the first RAN node may be an O-DU, and the second RAN node may be an O-RU.

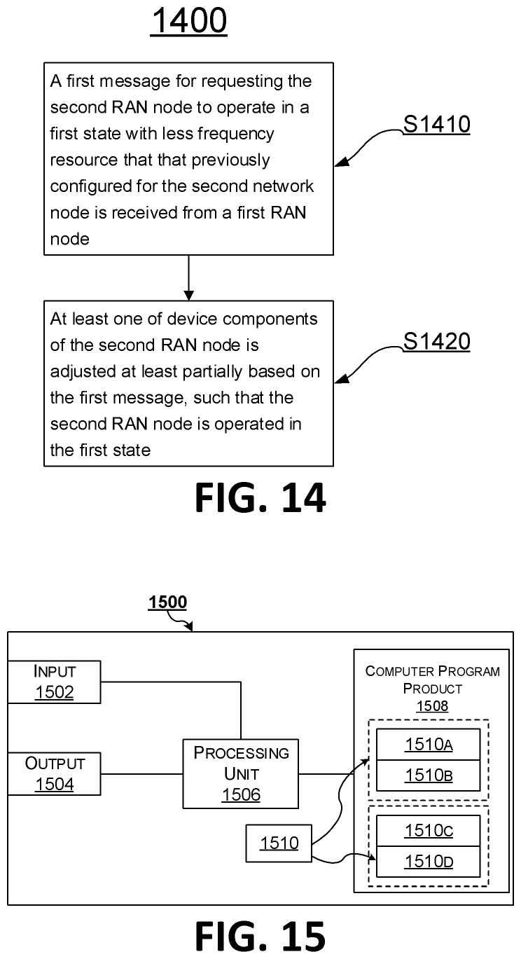

FIG. 14 is a flow chart of an exemplary method at a second RAN node for managing power consumption according to an embodiment of the present disclosure. The method 1400 may be performed at a second RAN node (e.g., the RU 230). The method 1400 may comprise steps S1410 and S1420. However, the present disclosure is not limited thereto. In some other embodiments, the method 1400 may comprise more steps, less steps, different steps, or any combination thereof. Further the steps of the method 1400 may be performed in a different order than that described herein when multiple steps are involved. Further, in some embodiments, a step in the method 1400 may be split into multiple sub-steps and performed by different entities, and/or multiple steps in the method 1400 may be combined into a single step.

The method 1400 may begin at step S1410 where a first message for requesting the second RAN node to operate in a first state with less frequency resource than that previously configured for the second RAN node may be received from a first RAN node.

At step S1420, at least one of device components of the second RAN node may be adjusted at least partially based on the first message, such that the second RAN node is operated in the first state.

In some embodiments, the method 1400 may further comprise: receiving, from the first RAN node, a second message for requesting the second RAN node to operate in a second state with the previously configured frequency resource; and adjusting at least one of device components of the second RAN node at least partially based on the second message, such that the second RAN node is operated in the second state. In some embodiments, the method 1400 may further comprise: receiving, from the first RAN node, a third message for requesting the second RAN node to operate in a third state with a newly configured frequency resource; and adjusting at least one of device components of the second RAN node at least partially based on the third message, such that the second RAN node is operated in the third state.

In some embodiments, the first message may indicate at least one of: a reduced carrier bandwidth; a duration for the reduced carrier bandwidth; a reduced PRB usage; and a duration for the reduced PRB usage. In some embodiments, a reduced carrier bandwidth and/or a reduced PRB usage may be indicated by a ratio of previously configured carrier bandwidth and/or a ratio of a previously configured number of PRBs, respectively. In some embodiments, the third message may indicate at least one of: a carrier bandwidth configured for the second RAN node; and a number of PRBs configured for the second RAN node.

In some embodiments, at least one of the first message, the second message, and the third message may be one of: a TR-DCI message that is transmitted via a CAT interface; an IQ control message that is transmitted via a IQC interface; an IQ control message that is transmitted via an CPRI or eCPRI interface; and a message that is transmitted via open fronthaul interface—M-Plane or C-Plane.

In some embodiments, the step of adjusting at least one of device components of the second RAN node at least partially based on the first message may comprise at least one of: deactivating at least one of the device components; lowering a sampling rate of at least one filter; lowering operation drain voltage for at least one power amplifier; and lowering CFR threshold of radio unit accordingly. In some embodiments, the step of adjusting at least one of device components of the second RAN node at least partially based on the second message may comprise at least one of: scheduling transmission from/to the second RAN node with a previously configured number of PRBs; scheduling transmission from/to the second RAN node with a previously configured carrier bandwidth; activating at least one of the device components; restoring at least one filter with a previously configured sampling rate; restoring at least one power amplifier with a previously configured operation drain voltage; and restoring CFR threshold of radio unit accordingly.

In some embodiments, the step of adjusting at least one of device components of the second RAN node at least partially based on the third message may comprise at least one of: scheduling transmission from/to the second RAN node with a newly configured number of PRBs; scheduling transmission from/to the second RAN node with a newly configured carrier bandwidth; activating at least one of the device components; operating at least one filter with a newly configured sampling rate; supplying at least one power amplifier with a newly configured operation drain voltage; and adjusting CFR threshold of radio unit accordingly

In some embodiments, the device components may comprise at least one of: one or more BF components; one or more digital filters; one or more TRX transceivers; and one or more PAs. In some embodiments, the first RAN node may be a DU, and the second RAN node may be an RU. In some embodiments, the first RAN node may be a cloud RAN CU, and the second RAN node may be an RU. In some embodiments, the first RAN node may be a BBU, and the second RAN node may be an RU. In some embodiments, the first RAN node may be an O-DU, and the second RAN node may be an O-RU.

FIG. 15 schematically shows an embodiment of an arrangement 1500 which may be used in a RAN node (e.g., the DU 220 or the RU 230) according to an embodiment of the present disclosure. Comprised in the arrangement 1500 are a processing unit 1506, e.g., with a Digital Signal Processor (DSP) or a Central Processing Unit (CPU). The processing unit 1506 may be a single unit or a plurality of units to perform different actions of procedures described herein. The arrangement 1500 may also comprise an input unit 1502 for receiving signals from other entities, and an output unit 1504 for providing signal(s) to other entities. The input unit 1502 and the output unit 1504 may be arranged as an integrated entity or as separate entities.

Furthermore, the arrangement 1500 may comprise at least one computer program product 1508 in the form of a non-volatile or volatile memory, e.g., an Electrically Erasable Programmable Read-Only Memory (EEPROM), a flash memory and/or a hard drive. The computer program product 1508 comprises a computer program 1510, which comprises code/computer readable instructions, which when executed by the processing unit 1506 in the arrangement 1500 causes the arrangement 1500 and/or the RAN node in which it is comprised to perform the actions, e.g., of the procedure described earlier in conjunction with FIG. 1 to FIG. 14 or any other variant.

The computer program 1510 may be configured as a computer program code structured in computer program modules 1510A and 1510B. Hence, in an exemplifying embodiment when the arrangement 1500 is used in a first RAN node for managing power consumption of a second RAN node, the code in the computer program of the arrangement 1500 includes: a module 1510A for determining whether one or more first conditions related to a traffic load of the second RAN node are fulfilled or not; and a module 1510B for transmitting, to the second RAN node, a first message for requesting the second RAN node to operate in a first state with less frequency resource than that previously configured for the second RAN node in response to determining that the one or more first conditions are fulfilled.

The computer program 1510 may be further configured as a computer program code structured in computer program modules 1510C and 1510D. Hence, in an exemplifying embodiment when the arrangement 1500 is used in a second RAN node for managing power consumption, the code in the computer program of the arrangement 1500 includes: a module 1510C for receiving, from a first RAN node, a first message for requesting the second RAN node to operate in a first state with less frequency resource that that previously configured for the second RAN node; and a module 1510D for adjusting at least one of device components of the second RAN node at least partially based on the first message, such that the second RAN node is operated in the first state.

The computer program modules could essentially perform the actions of the flow illustrated in FIG. 1 to FIG. 14, to emulate the first and/or second RAN nodes. In other words, when the different computer program modules are executed in the processing unit 1506, they may correspond to different modules in the first and/or second RAN nodes.

Although the code means in the embodiments disclosed above in conjunction with FIG. 15 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the RAN nodes.

Correspondingly to the method 1300 as described above, a first RAN node for managing power consumption of a second RAN node is provided. FIG. 16 is a block diagram of an exemplary first RAN node 1600 according to an embodiment of the present disclosure. The first RAN node 1600 may be, e.g., the DU 220 in some embodiments.

The first RAN node 1600 may be configured to perform the method 1300 as described above in connection with FIG. 13. As shown in FIG. 16, the first RAN node 1600 may comprise a determining module 1610 for determining whether one or more first conditions related to a traffic load of the second RAN node are fulfilled or not; and a transmitting module 1620 for transmitting, to the second RAN node, a first message for requesting the second RAN node to operate in a first state with less frequency resource than that previously configured for the second RAN node in response to determining that the one or more first conditions are fulfilled.

The above modules 1610 and/or 1620 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 13. Further, the first RAN node 1600 may comprise one or more further modules, each of which may perform any of the steps of the method 1300 described with reference to FIG. 13.

Correspondingly to the method 1400 as described above, a second RAN node for managing power consumption is provided. FIG. 17 is a block diagram of an exemplary second RAN node 1700 according to an embodiment of the present disclosure. The second RAN node 1700 may be, e.g., the RU 230 in some embodiments.

The second RAN node 1700 may be configured to perform the method 1400 as described above in connection with FIG. 14. As shown in FIG. 17, the second RAN node 1700 may comprise a receiving module 1710 for receiving, from a first RAN node, a first message for requesting the second RAN node to operate in a first state with less frequency resource that that previously configured for the second RAN node; and an adjusting module 1720 for adjusting at least one of device components of the second RAN node at least partially based on the first message, such that the second RAN node is operated in the first state.

The above modules 1710 and/or 1720 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 14. Further, the second RAN node 1700 may comprise one or more further modules, each of which may perform any of the steps of the method 1400 described with reference to FIG. 14.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| BBL1 | Base Band Layer1 |
| BS | Base Station |
| CAT | Common Access Tier |
| CPRI | Common Public Radio Interface |
| DU | Digital Unit |
| EE | Energy Efficiency |
| LESS | Low Energy Scheduler Solution |
| ORAN | Open RAN |
| RU | Radio Unit |
| SBPS | Symbol Based Power Save |

What is claimed is:

1. A method (1300) at a first Radio Access Network (RAN) node (720, 1120, 1150, 1220, 1500, 1600) for managing power consumption of a second RAN node (730, 1130, 1230, 1500, 1700), the method (1300) comprising:
determining (S1310) whether one or more first conditions related to a traffic load of the second RAN node (730, 1130, 1230, 1500, 1700) are fulfilled or not; and
transmitting (S1320), to the second RAN node (730, 1130, 1230, 1500, 1700), a first message for requesting the second RAN node (730, 1130, 1230, 1500, 1700) to operate in a first state with less frequency resource than that previously configured for the second RAN node (730, 1130, 1230, 1500, 1700) in response to determining that the one or more first conditions are fulfilled.

2. The method (1300) of claim 1, further comprising:
determining whether one or more second conditions related to the second RAN node (730, 1130, 1230, 1500, 1700) are fulfilled or not; and
transmitting, to the second RAN node (730, 1130, 1230, 1500, 1700), a second message for requesting the second RAN node (730, 1130, 1230, 1500, 1700) to operate in a second state with the previously configured frequency resource in response to determining that the one or more second conditions are fulfilled.

3. The method (1300) of claim 1, further comprising:
determining whether one or more third conditions related to the second RAN node (730, 1130, 1230, 1500, 1700) are fulfilled or not; and
transmitting, to the second RAN node (730, 1130, 1230, 1500, 1700), a third message for requesting the second RAN node (730, 1130, 1230, 1500, 1700) to operate in a third state with a newly configured frequency resource in response to determining that the one or more third conditions are fulfilled.

4. The method (1300) of any of claims 1 to 3, wherein the one or more first conditions comprise at least one of:
whether a current Physical Resource Block (PRB) load is lower than a configurable threshold; and
whether a predicted traffic load will be lower than a configurable threshold for a configurable time period.

5. The method (1300) of any of claims 1 to 3, wherein the one or more second conditions and/or the one or more third conditions comprise at least one of:
whether a current PRB load is higher than a configurable threshold; and
whether a predicted traffic load will not be lower than a configurable threshold for a configurable time period.

6. The method (1300) of claim 4 or 5, wherein the predicted traffic load is predicted by a data-driven Artificial Intelligence (AI) algorithm.

7. The method (1300) of any of claims 1 to 6, wherein the first message indicates at least one of:
a reduced carrier bandwidth;
a duration for the reduced carrier bandwidth;
a reduced PRB usage; and
a duration for the reduced PRB usage.

8. The method (1300) of claim 7, wherein a reduced carrier bandwidth and/or a reduced PRB usage is indicated by a ratio of a previously configured carrier bandwidth and/or a ratio of a previously configured number of PRBs, respectively.

9. The method (1300) of claim 7 or 8, wherein the first message is a message scheduling transmission from/to the second RAN node (730, 1130, 1230, 1500, 1700) with a reduced number of PRBs and/or with a reduced carrier bandwidth.

10. The method (1300) of any of claims 7 to 9, wherein the reduced number of PRBs and/or reduced carrier bandwidth are achieved by allocating a reduced number of continuous or discontinuous frequency resources.

11. The method (1300) of any of claims 1 to 10, wherein the third message indicates at least one of:
a carrier bandwidth configured for the second RAN node (730, 1130, 1230, 1500, 1700); and
a number of PRBs configured for the second RAN node (730, 1130, 1230, 1500, 1700).

12. The method (1300) of any of claims 1 to 11, wherein at least one of the first message, the second message, and the third message is one of:
a Transmit Receive-Device Control Interface (TR-DCI) message that is transmitted via a Common Access Tier (CAT) interface;
an In-phase Quadrature (IQ) control message that is transmitted via a Common IQ control path (IQC) interface;
an IQ control message that is transmitted via a Common Public Radio Interface (CPRI) or an evolved CPRI (eCPRI) interface; and
a message that is transmitted via open fronthaul interface—Management plane (M-Plane) or Control plane (C-Plane).

13. The method (1300) of any of claims 1 to 12, wherein the first RAN node (720, 1150, 1500, 1600) is a Digital Unit (DU), and the second RAN node (730, 1130, 1500, 1700) is a Radio Unit (RU).

14. The method (1300) of any of claims 1 to 12, wherein the first RAN node (1120, 1500, 1600) is a cloud RAN Central Unit (CU), and the second RAN node (1130, 1500, 1700) is an RU.

15. The method (1300) of any of claims 1 to 12, wherein the first RAN node (720, 1150, 1500, 1600) is a Baseband Unit (BBU), and the second RAN node (730, 1130, 1500, 1700) is an RU.

16. The method (1300) of any of claims 1 to 12, wherein the first RAN node (1220, 1500, 1600) is an ORAN Distributed Unit (O-DU), and the second RAN node (1230, 1500, 1700) is an ORAN Radio Unit (O-RU).

17. A first RAN node (720, 1120, 1150, 1220, 1500, 1600), comprising:
a processor (1506);
a memory (1508) storing instructions (1510) which, when executed by the processor (1506), cause the processor (1506) to perform the method (1300) of any of claims 1 to 16.

18. A method (1400) at a second RAN node (730, 1130, 1230, 1500, 1700) for managing power consumption, the method (1400) comprising:
receiving (S1410), from a first RAN node (720, 1120, 1150, 1220, 1500, 1600), a first message for requesting the second RAN node (730, 1130, 1230, 1500, 1700) to operate in a first state with less frequency resource that that previously configured for the second RAN node (730, 1130, 1230, 1500, 1700); and
adjusting (S1420) at least one of device components of the second RAN node (730, 1130, 1230, 1500, 1700) at least partially based on the first message, such that the second RAN node (730, 1130, 1230, 1500, 1700) is operated in the first state.

19. The method (1400) of claim 18, further comprising:
receiving, from the first RAN node (720, 1120, 1150, 1220, 1500, 1600), a second message for requesting the second RAN node (730, 1130, 1230, 1500, 1700) to operate in a second state with the previously configured frequency resource; and
adjusting at least one of device components of the second RAN node (730, 1130, 1230, 1500, 1700) at least partially based on the second message, such that the second RAN node (730, 1130, 1230, 1500, 1700) is operated in the second state.

20. The method (1400) of claim 18 or 19, further comprising:
receiving, from the first RAN node (720, 1120, 1150, 1220, 1500, 1600), a third message for requesting the second RAN node (730, 1130, 1230, 1500, 1700) to operate in a third state with a newly configured frequency resource; and
adjusting at least one of device components of the second RAN node (730, 1130, 1230, 1500, 1700) at least partially based on the third message, such that the second RAN node (730, 1130, 1230, 1500, 1700) is operated in the third state.

21. The method (1400) of any of claims 18 to 20, wherein the first message indicates at least one of:
a reduced carrier bandwidth;
a duration for the reduced carrier bandwidth;
a reduced PRB usage; and
a duration for the reduced PRB usage.

22. The method (1400) of claim 21, wherein a reduced carrier bandwidth and/or a reduced PRB usage is indicated by a ratio of previously configured carrier bandwidth and/or a ratio of a previously configured number of PRBs, respectively.

23. The method (1400) of any of claims 18 to 22, wherein the third message indicates at least one of:
a carrier bandwidth configured for the second RAN node (730, 1130, 1230, 1500, 1700); and
a number of PRBs configured for the second RAN node (730, 1130, 1230, 1500, 1700).

24. The method (1400) of any of claims 18 to 23, wherein at least one of the first message, the second message, and the third message is one of:
a TR-DCI message that is transmitted via a CAT interface;
an IQ control message that is transmitted via a IQC interface;
an IQ control message that is transmitted via an CPRI or eCPRI interface; and
a message that is transmitted via open fronthaul interface—M-Plane or C-Plane.

25. The method (1400) of any of claims 18 to 24, wherein the step of adjusting at least one of device components of the second RAN node (730, 1130, 1230, 1500, 1700) at least partially based on the first message comprises at least one of:
deactivating at least one of the device components;
lowering a sampling rate of at least one filter;
lowering operation drain voltage for at least one power amplifier; and
lowering Crest Factor Reduction (CFR) threshold of radio unit accordingly.

26. The method (1400) of any of claims 18 to 25, wherein the step of adjusting at least one of device components of the second RAN node (730, 1130, 1230, 1500, 1700) at least partially based on the second message comprises at least one of:
scheduling transmission from/to the second RAN node (730, 1130, 1230, 1500, 1700) with a previously configured number of PRBs;
scheduling transmission from/to the second RAN node (730, 1130, 1230, 1500, 1700) with a previously configured carrier bandwidth;
activating at least one of the device components;
restoring at least one filter with a previously configured sampling rate;
restoring at least one power amplifier with a previously configured operation drain voltage; and
restoring CFR threshold of radio unit accordingly.

27. The method (1400) of any of claims 18 to 26, wherein the step of adjusting at least one of device components of the second RAN node (730, 1130, 1230, 1500, 1700) at least partially based on the third message comprises at least one of:
scheduling transmission from/to the second RAN node (730, 1130, 1230, 1500, 1700) with a newly configured number of PRBs;
scheduling transmission from/to the second RAN node (730, 1130, 1230, 1500, 1700) with a newly configured carrier bandwidth;
activating at least one of the device components;
operating at least one filter with a newly configured sampling rate;
supplying at least one power amplifier with a newly configured operation drain voltage; and
adjusting CFR threshold of radio unit accordingly

28. The method (1400) of any of claims 18 to 27, wherein the device components comprise at least one of:
one or more Beamforming (BF) components;
one or more digital filters;
one or more TRX transceivers; and
one or more PAS.

29. The method (1400) of any of claims 18 to 28, wherein the first RAN node (720, 1150, 1500, 1600) is a DU, and the second RAN node (730, 1130, 1500, 1700) is an RU.

30. The method (1400) of any of claims 18 to 28, wherein the first RAN node (1120, 1500, 1600) is a cloud RAN CU, and the second RAN node (1130, 1500, 1700) is an RU.

31. The method (1400) of any of claims 18 to 28, wherein the first RAN node (720, 1150, 1500, 1600) is a BBU, and the second RAN node (730, 1130, 1500, 1700) is an RU

32. The method (1400) of any of claims 18 to 28, wherein the first RAN node (1220, 1500, 1600) is an O-DU, and the second RAN node (1230, 1500, 1700) is an O-RU.

33. A second RAN node (730, 1130, 1230, 1500, 1700), comprising:
a processor (1506);
a memory (1508) storing instructions (1510) which, when executed by the processor (1506), cause the processor (1506) to perform the method (1400) of any of claims 18 to 32.

34. A network node comprising:
a first RAN node (720, 1120, 1150, 1220, 1500, 1600) of claim 17; and
one or more second RAN nodes (730, 1130, 1230, 1500, 1700) of claim 33.

35. A computer program (1510) comprising instructions which, when executed by at least one processor (1506), cause the at least one processor (1506) to carry out the method (1300, 1400) of any of claims 1 to 16 and 18 to 32.

36. A carrier (1508) containing the computer program (1510) of claim 35, wherein the carrier is one of an electronic signal, optical signal, radio signal, or computer readable storage medium.
